(19) United States
(12) Patent Application Publication
(10) Pub. No.: US 2004/0034833 A1
(43) Pub. Date: Feb. 19, 2004

(54) Dynamic interaction manager for markup language graphical user interface

(76) Inventors: Panagiotis Kougiouris, San Jose, CA (US); Chip Bering, San Jose, CA (US); Rajesh Tiwari, Sunnyvale, CA (US)

Correspondence Address: PENNIE AND EDMONDS, 1155 AVENUE OF THE AMERICAS, NEW YORK, NY, 100362711

(21) Appl. No.: 10/640,667

(22) Filed: Aug. 13, 2003

Related U.S. Application Data
(63) Continuation of application No. 09/441,218, filed on Nov. 15, 1999, now abandoned.
(60) Provisional application No. 60/165,127, filed on Nov. 12, 1999.

(51) Int. Cl. G06F 17/00

(52) U.S. Cl. 715/513

(57) ABSTRACT

A system and method for enabling data management operations to automatically be applied to data associated with a markup language GUI element is disclosed. An author of a markup language file may include various custom markup language attributes in order to automatically bind a GUI element to a data element and automatically perform a data management operation on the GUI element text, e.g. a formatting/validation operation.

The data management procedures may be managed by an executable component referred to as a “dynamic interaction manager”. The markup language file may include a tag for instantiating the dynamic interaction manager, as appropriate to a particular markup language.

The dynamic interaction manager is operable to dynamically perform data management operations for GUI elements, based on the custom markup language attributes. The dynamic interaction manager may interface with the application displaying the markup language GUI in order to receive dynamic programmatic events from the application. For example, as a user presses keys to type text into a social security number field, the application may generate a “KeyUp” event as each key is released. In response to receiving the “KeyUp” event associated with the social security number field, the dynamic interaction manager may be operable to retrieve the text from the field, e.g., via a document object, and then perform a data management operation, such as a validation/formatting operation, on the text.

Custom attributes specifying how the dynamic interaction manager should respond to events associated with a GUI element may be added to a GUI element description in the markup language file.

After calling a appropriate data management component and receiving the results of the data management operation, the dynamic interaction manager may take any of various actions, as appropriate, e.g., by changing the visual appearance of a GUI element in response to determining the GUI element text is invalid.

### PRIORITY CLAIM

This application claims benefit of priority of U.S. provisional application Serial No. ______titled “Dynamic Interaction Manager for a Markup Language Graphical User Interface”, filed Nov. 12, 1999, whose inventors were Panagiotis Kougiouris and Chip Bering.

### RESERVATION OF COPYRIGHT

A portion of the disclosure of this patent document contains material to which a claim of copyright protection is made. The copyright owner has no objection to the facsimile reproduction by anyone of the patent document or the patent disclosure as it appears in the Patent and Trademark Office patent file or records, but reserves all other rights whatsoever.

### FIELD OF THE INVENTION

The present invention relates to the filed of data management for application programs, and more particularly, to a system and method for automatically performing various aspects of data management based on a markup language description for a graphical user interface (GUI). DESCRIPTION OF THE RELATED ART

Graphical user interfaces (GUIs) based on markup language descriptions are becoming increasingly important and common in applications. This is in part due to the popularity and importance of the World Wide Web and web applications, many of which utilize graphical user interfaces created from markup language descriptions, such as HTML or XML-derived markup language descriptions. GUIs created from markup languages may enable users to interact with an application using a familiar type of user interface.

Markup language GUIs may also enable software developers to develop user interfaces that are largely separated form application logic. However, many existing markup language files comprising GUI information include not only markup language descriptions of the GUI elements, but also code for managing data associated with various GUI elements. For example, many GUI text fields are designed to accept data input or display data output that is formatted or demarcated according to a particular code or pattern, such as a social security number pattern or a telephone number pattern. Thus, markup language files often include code for formatting or validating data associated with such GUI text fields, e.g., in order to save the data in a standard format. For example, an HTML file may include Javascript code that performs such formatting/validation operations.

There are several drawbacks associated with this approach of mixing data management code with GUI markup language descriptions. For example, the code may need to be included in each file needing the data management operations to be performed, which may make the application difficult to maintain, may expose portions of application logic to users, etc. Another potential problem is that code for implementing data management operations can be tedious and time-consuming to implement. For example, implementing algorithms for performing formatting/validation operations for complex codes or patterns may be prone to errors, and it may be difficult to verify that the algorithms work correctly for all cases.

Thus, it may be desirable to enable common types of data management operations to be performed automatically, rather than requiring application developers or markup language file authors to implement the data management operations themselves.

Certain application development platforms support the concept of “data binding” with respect to GUI elements defined in markup language files. Briefly, the term data binding, as used herein, refers to a relationship in which a GUI element is bound to a data element. The data element for the GUI element may be specified in the markup language description for the GUI element, and an application may automatically perform the binding to the data element. For example, when processing a markup language file comprising a GUI element, an application may interface with a data source in order to retrieve the appropriate data and automatically display the data in the GUI element when the GUI appears on the display screen. For more information on data binding as it relates to HTML GUI elements, please refer to the below-incorporated references.

Thus, data binding technology provides support for the automatic transfer of data to and from GUI elements, helping to maintain the distinction between data and the markup language description of the GUI for displaying the data. It would be desirable to extend this functionality to allow not only the binding of a GUI element to a data source, but to also enable the various common data management operations to automatically be applied to data associated with a GUI element.

### SUMMARY OF THE INVENTION

The problems outlined above may in large part be solved by providing a system and method for enabling data management operations to automatically be applied to data associated with a markup language GUI element. The markup language may be any of various markup languages, including HTML and XML-derived markup languages. The graphical user interface markup language description may comprise descriptions of various types of graphical user interface elements for which data is to be managed, such as form fields, tables, hypertext links, etc.

An author of a markup language file may include various custom markup language attributes in order to automatically bind a GUI element to a data element and automatically perform a data management operation on the GUI element text, e.g. a formatting/validation operation.

The data management procedures may be managed by an executable component referred to as a “dynamic interaction manager”. The markup language file may include a tag for instantiating the dynamic interaction manager, as appropriate to a particular markup language. For example, an HTML file may include an <object> or <applet> tag for instantiating the manager. The tag for instantiating the dynamic interaction manager may include attributes or sub-tags for specifying the default behavior of the dynamic interaction, manager.

The dynamic interaction manager is operable to dynamically perform data management operations for GUI elements, based on the custom markup language attributes. The dynamic interaction manager may obtain a reference to a document object describing the markup language file and its various elements, or may be passed a reference to such a document object when the component is instantiated. For example, for an HTML file, this document object may be constructed based on the standard HTML Document Object Model (DOM) or a variant of the DOM, such as Microsoft's Dynamic HTML Object Model. The dynamic interaction manager, may traverse the document object in order to determine information regarding the custom data management attributes associated with each GUI element.

The dynamic interaction manager may interface with the application displaying the markup language GUI in order to receive dynamic programmatic events from the application. For example, as a user presses keys to type text into a social security number field, the application may generate a “KeyUp” event as each key is released. In response to receiving the “KeyUp” event associated with the social security number field, the dynamic interaction manager may be operable to retrieve the text from the field, e.g., via the document object, and then perform a data management operation, such as a validation/formatting operation, on the text.

Custom attributes specifying how the dynamic interaction manager should respond to events associated with a GUI element may be added to a GUI element description in the markup language file.

In one embodiment, the dynamic interaction manager is operable to perform the various data management procedures itself. However, in the preferred embodiment, the dynamic interaction manager interfaces with various data management components. For example, the system may include a set of data management components related to performing formatting/validation procedures, where each validation/formatting data management component may correspond to a particular text pattern or code. As described below, the dynamic interaction manager may use an attribute describing the pattern or code associated with a GUI element, e.g., the HSFORMAT=“usssn” example attribute shown above, in order to determine the appropriate validation/formatting data management component.

Each data management component preferably provides methods according to a standard data management interface, so that the dynamic interaction manager may call each data management component independently of the particular text pattern or code associated with the component. Thus, data management components may be added to the framework as desired.

After calling the appropriate method of the data management component and receiving the results, the dynamic interaction manager may take any of various actions, as appropriate. For example, in response to determining that the text for a GUI element is invalid, the dynamic interaction manager may cause the GUI element text to turn red, e.g., by setting a property in the document object controlling the GUI element text color. As another example, in response to receiving a properly formatted text buffer in accordance with a particular text pattern or code, the dynamic interaction manager may re-set the GUI element text value to use the formatted text. As described below, various aspects of the behavior of the dynamic interaction manager, such as when to call data management methods, what to do in response to receiving the method results, etc., may be specified by adding custom attributes to the markup language file.

### BRIEF DESCRIPTION OF THE DRAWINGS

A better understanding of the present invention can be obtained when the following detailed description of the preferred embodiment is considered in conjunction with the following drawings, in which:

FIG. 1 illustrates one embodiment of a system enabling automatic data management operations for data associated with markup language graphical user interface (GUI) elements;

FIG. 2 is a flowchart diagram illustrating one embodiment of a process for performing data management operations for a graphical user interface created from a markup language description;

FIG. 3 illustrates one embodiment of a dynamic interaction manager for use in conjunction with a GUI created from an HTML description;

FIGS. 4A-4C illustrate an example of a GUI created from an HTML description, where the HTML description comprises information usable by a dynamic interaction manager for performing data binding and data management operation;

FIG. 5 illustrates one embodiment of a standard validation/formatting interface that data management components associated with performing validation/formatting operations may support; and

FIG. 6 illustrates an embodiment employing a factory component.

While the invention is susceptible to various modifications and alternative forms specific embodiments are shown by way of example in the drawings and are herein described in detail. It should be understood however, that drawings and detailed description thereto are not intended to limit the invention to the particular form disclosed. But on the contrary the invention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The: following references are hereby incorporated by reference.

For information on the Component Object Model, please refer to: Box, Essential COM, Addison-Wesley, 1998; or to Chappell, Understanding ActiveX and OLE, Microsoft Press, 1996.

For information on constructing applications that utilize the Microsoft Internet Explorer code base, please refer to: Isaacs, Inside Dynamic HTML, Microsoft Press, 1997; or to Roberts, Programming Microsoft Internet Explorer 5, Microsoft Press, 1999.

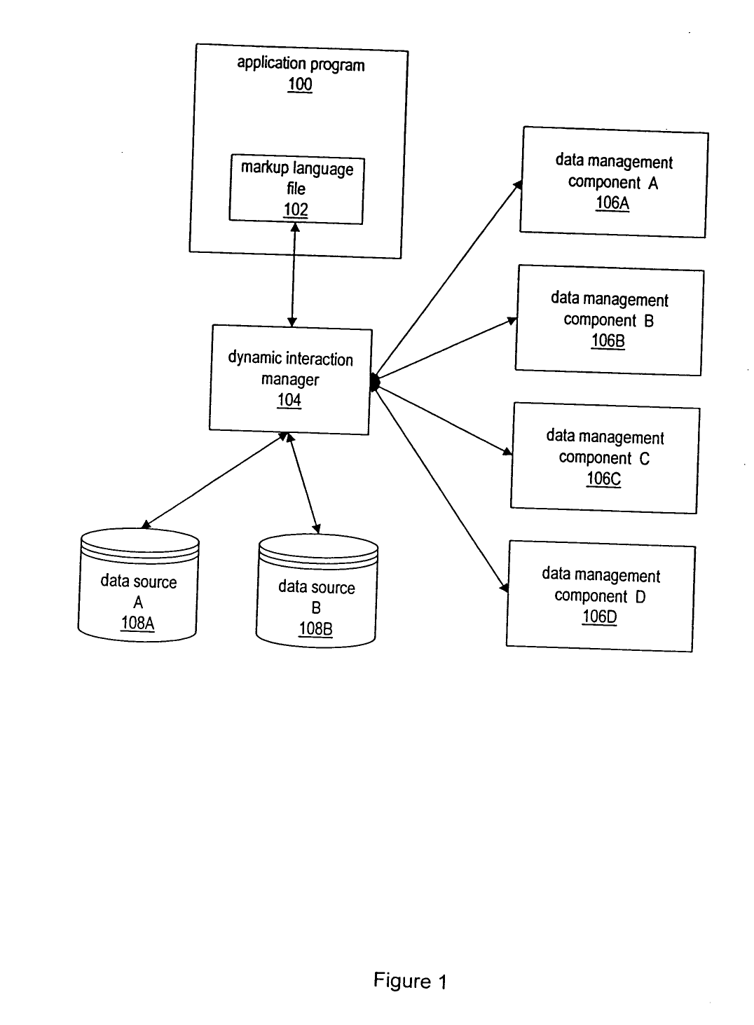

FIG. 1—System for Automatic Validation/Formatting

FIG. 1 illustrates one embodiment of a system enabling automatic data management operations for data associated with markup language graphical user interface (GUI) elements.

The embodiment of FIG. 1 illustrates an application program 100, which processes a markup language file 102. The application program 100 may be any type of application program enabled to process a markup language file. For example, the application program may be a web browser application enabled to process an HTML file or an XML-derived markup language file. The application program 100 may also be an application that is not considered to be a web browser application per se, but includes web browsing capabilities. For example, various web browser applications, such as the Microsoft Internet Explorer web browser, enable applications to interface with the web browser code base, in order to utilize its capabilities. Thus, the application program 100 may itself provide the executable code for processing the markup language file 102, or the application program 100 may interface with another application which processes the markup language file 102.

The markup language file 102 may be a file comprising any type of markup language code, such as HTML code, XML-derived markup language code, or another type of markup language code. The markup language file may include a description of a graphical user interface, i.e., various markup language descriptions of GUI elements, which the application program 100 is operable to process and display a graphical user interface corresponding to the GUI elements. The GUI description may comprise descriptions of GUI elements with which data may be associated in various ways. For example, a GUI element may comprise one or more fields for accepting text input and/or displaying text output, may comprise a text label, etc. Examples of GUI elements with which data may be associated include form fields, tables, hypertext links, etc.

As shown in FIG. 1, a dynamic interaction manager 104 interfaces with the application program 100. The dynamic interaction manager 104 may interface with the application program in any of various ways, as supported by a particular application program. For example, for a Windows-based application, the dynamic interaction manager may be a component that interfaces with the application via Component Object Model (COM) interfaces. In other embodiments, the dynamic interaction manager and the application may communicate using other means, such as Java interfaces, CORBA interfaces, etc.

In one embodiment, the dynamic interaction manager 104 is an executable component that is instantiated in response to the application program 100 processing the markup language file 102. The markup language file may comprise markup language code, e.g., a particular tag, causing the application program to instantiate the dynamic interaction manager. For example, an HTML markup language file may comprise an <OBJECT> or an <APPLET> tag for instantiating the dynamic interaction manager. The dynamic interaction manager 104 may be any of various types of executable modules or components, as supported by a particular application and environment, such as an ActiveX/COM object, a Java object, etc. As an example, in a Windows application processing an HTML file, the dynamic interaction manager may be instantiated with markup language code such as:

<OBJECT

ID=“hsDHTMLCt1”
CLASS ID=“clsid:17F34ED5-FB59-11D1-801A-00201829472A”
ALIGN=“baseline” BORDER=“0” WIDTH=“0” HEIGHT=“0”>

</OBJECT>

The dynamic interaction manager 104 is enabled to receive programmatic user interface events associated with the markup language GUI from the application program 100, using appropriate means for a particular embodiment. For example, for a dynamic interaction manager that interfaces with an application program via COM interfaces, the dynamic interaction manager may receive programmatic events via a COM connection point event mechanism. In one embodiment, the application program 100 utilizes the Microsoft. Internet Explorer code base to process the markup language file and display the GUI, and the dynamic interaction manager 104 interfaces with the Internet Explorer components in order to receive events associated with the GUI. For more information on interfacing with Internet Explorer components, please refer to the above-incorporated references.

The dynamic interaction manager 104 may receive various types of user interface events from the application program 100, depending on the particular embodiment. Each type of GUI element, e.g. table cell, hypertext link, etc., may have a particular set of associated user interface events. As examples, user interface events may correspond to the following actions performed on a GUI element:

changing the value of the GUI element

pressing a key

releasing a key

causing the GUI element to gain user interface focus

causing the GUI element to lose user interface focus

moving a mouse pointer over the GUI element

moving a mouse pointer away from the GUI element

clicking on the GUI element

double-clicking on the GUI element

This list is exemplary only, and actions performed on a GUI element may cause the application program 100 to send many other types of events to the dynamic interaction manager 104. It is noted that the dynamic interaction manager 104 may receive user interface events that are initiated in response to a user action, e.g., a mouse click, or are initiated in response to a programmatic action, e.g., programmatically setting the text value of an input field.

As shown in FIG. 1, the dynamic interaction manager 104 may interact with one or more data sources 108. As described above, the application program 100 may support the concept of data binding, wherein GUI elements are bound to particular data elements.

The dynamic interaction manager may enable this data binding by performing such operations as retrieving the data for a GUI element from a data source, transferring the data associated with a GUI element back to a data source, etc. The dynamic interaction manager may also provide various methods that clients, e.g., components of the application program 100, can call to manipulate the data associated with GUI elements in various ways, as described below.

The data sources 108 may be any of various types of data sources. For example, a data source may be a database or file, or the dynamic interaction manager may request data from another process. A data source may be located remotely with respect to the computer that the application program 100 runs on. For example, the application program 100 may be the client side of a client/server application, such as an Internet application, and the dynamic interaction manager 104 may communicate with a server-side process in order to retrieve data from or store data to a server-side data source.

Additionally, as shown in FIG. 1 and described below, the dynamic interaction manager 104 may interact with various types of data management components 106 in order to perform data management operations on the data associated with GUI elements. For example, a data management component 106 may be operable to validate/format text according to a particular pattern or code. The interaction of the dynamic interaction manager 104 with data management components 106 is described below.

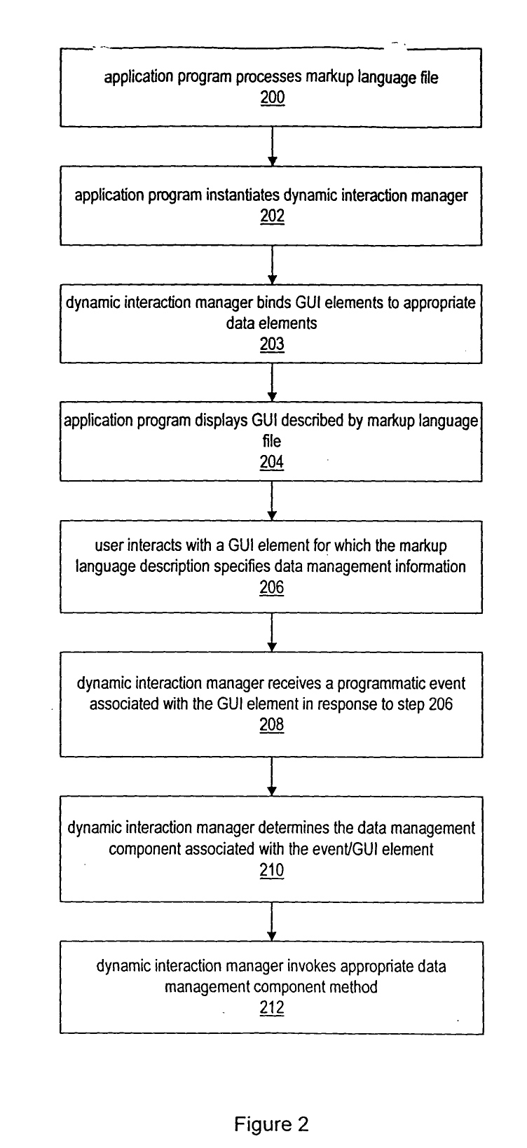

FIG. 2—Validating/Formatting Process

As described above, the markup language file may comprise descriptions of various GUI elements of a graphical user interface. The GUI may comprise any of various types of user interface elements, and the application may display the GUI in any of various ways, depending on the particular markup language, the way the application is configured to process the markup language, the particular computer system the application is running on, etc. An example of an HTML markup language file and its associated GUI are discussed below.

As described above, an application program, in conjunction with the dynamic interaction manager, may be enabled to perform data binding of GUI elements to data elements. The markup language file GUI descriptions may comprise information usable by the dynamic interaction manager to map GUI elements to data elements. For example, an HTML input form field element may have a description such as:

<INPUT NAME“COB code:”

HSTYPE=“ string”
HSDATASRC=“#hsDHTMLRDS”
HSDATAFLD=“cobcode”>

where the HSDATASRC specifies a particular data source that the dynamic interaction manager is configured to interact with, and the HSDATAFLD attribute specifies a particular data element associated with the data source. For example, the HSDATASRC value may identify a particular database table, and the HSDATAFLD attribute may identify a column of the table. However, as noted above, the dynamic interaction manager may interact with any of various types of data sources; e.g., the dynamic interaction manager may interface with a server data source. In one embodiment, the application program may utilize the Internet Explorer code base, and the dynamic interaction manager may interface with the IE code base in order to implement the type of data binding described herein. For more information regarding such an embodiment, please refer to the above-incorporated references.

The markup language file GUI descriptions may also comprise information usable by the dynamic interaction manager to perform various types of data management operations. This information may exist as markup language tag attributes, e.g., by adding custom data management attributes to a standard markup language (or by incorporating the data management attributes into the specification of the markup language). For example, the above HTML input form field element may be modified to have a description such as:

<INPUT NAME=“COB code:”

HSDATASRC=“#hSDHTMLRDS”
HSDATAFLD=“cobcode”
HSTYPE=“ string”
HS FORMAT= “COBcode”
HSVALKEYUP=“ 1” >

In this example, the HSVALKEYUP=“1” attribute may specify that the dynamic interaction manager should perform a validation operation for the input element text value in response to a particular user action performed on the input element, i.e., pressing and releasing a key. The dynamic interaction manager may be operable to use the HSFORMAT=“COBcode” attribute to associate the input element with a particular pattern or code according to which the data should be validated, i.e., a Coordination of Benefits (COB) health insurance code.

Thus, the custom data management attributes, in conjunction with the data binding attributes, may provide a flexible mechanism enabling markup language authors to easily bind a GUI elements to a data element, specify data management operations to perform for the GUI element, and specify the conditions for performing these data management operations.

The dynamic interaction manager may be operable to determine the data binding and data management information specified in the GUI descriptions in any of various ways. For example, in one embodiment, the dynamic interaction manager may obtain a reference to a “document object” describing the markup language file. The dynamic interaction manager may obtain a reference to the document object by being passed a reference to the document object when the manager component is instantiated. The document object may encapsulate objects, e.g., object-oriented style objects, that are arranged in a hierarchy and are related to each other in such a way as to form a representation of the markup language file and its various elements.

For example, for an HTML file, the document object may be created according to the standard HTML Document Object Model (DOM) or a variant of the DOM, such as Microsoft's Dynamic HTML Object Model. In this case, the document object may encapsulate an object hierarchy comprising objects representing various HTML elements comprised in the HTML file, such as frames, images, links, etc. For more information on the DOM, please refer to the World Wide Web Consortium's DOM Specification or to the above-incorporated references. As another example, for an XML file, the document object may be created according to the XML Object Model.

The document object is preferably created by the application program, as part of processing the markup language file. For example, web browser programs (or programs using web browser program components) are typically enabled to create a document object according to the HTML Document Object Model as part of processing an HTML file.

After obtaining or receiving a reference to a document object describing the markup language file, the dynamic interaction manager may traverse the document object, checking to see whether each of the various GUI element descriptions comprise data binding or data management information, e.g., stored as attributes such as described above. It is noted that data management information may be listed in the markup language file so that the information applies to multiple GUI elements. For example, for an HTML table element, the <TABLE> tag itself may comprise an HSFORMAT=“phone” attribute, so that a telephone number pattern is associated with all table cells by default. In this example, individual table cells may then override the default information, e.g., by including their own HSFORMAT=“date” attribute in the table cell description. The dynamic interaction manager is preferably enabled to associate the appropriate data management information with each GUI element.

The markup language code for instantiating the dynamic interaction manager may also include information for specifying the default data management behavior of the dynamic interaction manager, e.g., as attributes or sub-tags of an instantiation tag. For example, the dynamic interaction manager instantiation example described with reference to FIG. 1 may have a parameter sub-tag, such as

<OBJECT

ID=“hsDHTMLCt1”
CLASSID=“clsid:17F34ED5-FB59-11D1-801A-00201829472A”
ALIGN=“baseline” BORDER=“0” WIDTH=“0” HEIGHT=“0”>

<PARAM NAME“ validateOnKeyUp” VALUE=“0”>
</OBJECT>

where the <PARAM> sub-tag specifies that the dynamic interaction manager should not perform data validation operations in response to “KeyUp” events for a GUI element, unless the GUI element description explicitly overrides this, as shown in the above input form field, element example.

FIG. 2 is a flowchart diagram illustrating one embodiment of a process for performing data management operations for a graphical user interface created from a markup language description.

As shown in step 200 of FIG. 2, an application program processes a markup language file comprising a description of a graphical user interface.

In step 202, the application program instantiates a dynamic interaction manager. For example, as described above, the markup language file may comprise information, e.g., a tag, causing the application to instantiate the dynamic interaction manager.

In step 203, the dynamic interaction manager binds GUI elements to their appropriate data elements. Step 203 may comprise the dynamic interaction manager traversing the document object to determine which data elements are bound to which GUI elements, and may involve retrieving the respective data elements from their respective data sources. For example, the data for one GUI element may come from a database, while the data for another GUI element may come from a remote server. The dynamic interaction manager is responsible for handling the retrieval of data and the binding of the data to the GUI elements. This binding of data to GUI elements may involve creating internal data structures, such as a recordset, that maps GUI elements to their respective data values.

In step 204, the application program displays the GUI described in the markup language file. As described above, the GUI may comprise various GUI elements for which data management information is specified in the markup language file.

In step 206, a user interacts with a GUI element for which data management information is specified in the markup language file. This user interaction may comprise any of various actions, such as changing the value of the GUI element, moving a mouse pointer over the GUI element, or other actions, such as described above with reference to FIG. 1. The user interaction of step 206 preferably causes the application program to generate a programmatic event associated with the GUI element, which the dynamic interaction manager is operable to receive in step 208. The interface between the application program and the dynamic interaction manager is discussed above.

As described above, the markup language file may comprise information regarding what types of data management operations the dynamic interaction manager should perform and what user interface events the dynamic interaction manager should respond to, and the dynamic interaction manager may be enabled to perform certain data management operations, such as validating/formatting operations, by default in response to receiving certain events. If the default configuration and/or the data management information for the GUI element do not specify that the dynamic interaction manager should perform a data management operation for the event received in step 208, then the dynamic interaction manager may ignore the event.

In step 210, the dynamic interaction manager determines a data management component associated with the GUI element and the received event. For example, if a GUI element comprises an HSFORMAT attribute associating the GUI element data with a particular format or code, such as the COB code example described above, the dynamic interaction manager may use the format information to determine a particular validation/formatting component associated with the GUI element, in response to receiving a particular type of event, such as a “KeyUp” event. Note that the data management component identified by the dynamic interaction manager in step 210 may differ, depending on what type of event is received in step 208.

A generic framework architecture is preferably utilized, enabling new data management components to be easily “plugged in”. Thus, the dynamic interaction manager may not need knowledge of particular data management operations or knowledge of how to instantiate particular data management components for performing these operations. For example, for each type or class of data management operation, e.g. formatting/validation operations, the dynamic interaction manager may call a factory component responsible for instantiating the appropriate data management component.

The dynamic interaction manager may simply pass the factory component the value of an attribute in the markup language file as an argument for identifying the appropriate data management component. For example, for performing a data formatting operation for above input form field description, the manager component may obtain the HSFORMAT=“COBcode” attribute information from the document object and pass the value “COBcode” as an argument to a factory component associated with validation/formatting components. For example, the dynamic interaction manager may call a “GetComponent( )” method provided by the factory component, where this method returns a reference to an appropriate validation/formatting component instantiation.

In step 212, the dynamic interaction manager requests the data management component to perform a data management operation on the GUI element data. The dynamic interaction manager may obtain the GUI element data in any of various ways, e.g. by dynamically obtaining the data from the document object, by receiving the data as an argument along with the event in step 208, etc. The dynamic interaction manager may then request the data management component to perform the appropriate data management operation, as determined by the event received in step 208, the data management information specified in the GUI element markup language description, and the default configuration of the dynamic interaction manager. The dynamic interaction manager may perform this request by calling a method provided by the data management component, passing the GUI element data as an argument.

In one embodiment, components for each class of data management operation may provide methods according to standard interfaces that the dynamic interaction manager has knowledge of. For example, validation/formatting components may provide methods in accordance with a standard validation/formatting interface, enabling the dynamic interaction manager to validate/format data independently of the particular pattern or code, as described above. For example, a validation/formatting interface may define methods such as IsValid( ), for determining whether the data is valid data for the particular code, GetConforming( ), to get a properly formatted version of the data, etc. One embodiment of such a validation/formatting interface is described below.

In step 214, the dynamic interaction manager receives the request results from the data management component and proceeds accordingly, depending on such factors as: the particular event received, the default behavior programmed for the manager component, the behavior specified in the data management information in the markup language file, etc.

As one example, the dynamic interaction manager may be enabled to perform a validation operation for data for a GUI element when a user presses a key to change the GUI element text, i.e., when the dynamic interaction manager receives a “KeyUp” event indicating that the user pressed a key. For example, in response to receiving this event, the dynamic interaction manager may call an IsValid( ) method provided by a validation/formatting data management component for the GUI element's associated pattern or code, passing the GUI element text as an argument. For a Boolean value of “False” received from the IsValid( ) method, the dynamic interaction manager may be configured by default to display an informational window or dialog box to the user, informing the user of the invalid text. However, the GUI element description may include an attribute overriding this default behavior for invalid text. For example, an HTML input form field description may appear as:

<INPUT NAME=“COB code:”

HSDATASRC=“#hsDHTMLRDS”
HSDATAFLD=“cobcode”
HSTYPE=“string”
HS FORMAT= COBcode”
HSVALKEYUP=“ 1”
HSINVCLASS=“INVALIDORANGE”>

where the HSINVCLASS=“INVALIDORANGE” attribute indicates that the dynamic interaction manager should cause the GUI element text to turn orange, instead of the default behavior of displaying a window. Advantageously, various “invalid” styles may be defined, and any appropriate style may be applied to indicate an invalid value. For example, INVALIDORANGE may be defined as

</STYLE>
<STYLE TYPE=“text/css”>
.INVALIDORANGE {

background:#FFC800;

}
</STYLE>

which uses style sheet mechanisms supported by HTML to define a style. Various other invalid styles may of course be defined, as appropriate for a particular application.

It will be obvious that many various data management attributes may be supported, and that the dynamic interaction manager may be enabled to perform any of various actions in response to receiving the request results from the data management component, as appropriate for a particular situation. For example, the dynamic interaction manager may cause the visual appearance of GUI elements to be altered in various ways, the dynamic interaction manager may cause user actions to be ignored, e.g. a key press that would result in an invalid data value, etc. As discussed above, the dynamic interaction manager may interface with the application in any of various ways in order to cause these actions to occur. In one embodiment, the dynamic interaction manager may set properties of the document object, and the application is enabled to dynamically alter the GUI accordingly. For example, for an HTML GUI, this ability is referred to as “Dynamic HTML”. For more information on dynamic HTML, please refer to the above-incorporated references.

As noted above, FIG. 2 represents an exemplary embodiment of a process for performing data management operations for a graphical user interface created from a markup language description, and various steps of FIG. 2 may, of course, be altered, omitted, combined, added, etc.

For example, although the discussion above focuses on a user interface event generated as a result of a user action, such as a key press, the dynamic interaction manager may also receive events resulting from a programmatic action. For example, programmatically setting the value of a GUI element may cause the dynamic interaction manager to receive a “ValueChanged” event associated with the GUI element. Thus, for example, if unformatted data is retrieved from a database and used to populate a GUI element when the GUI is initially displayed, the dynamic interaction manager may automatically receive a “ValueChanged” event generated as a result of populating the GUI element, may format the data appropriately, and may reset the GUI element value to use the formatted data.

The time at which various aspects of FIG. 2 occur may, of course, be altered or tailored to a specific embodiment, as appropriate. For example, the dynamic interaction manager may instantiate each of the data management components for the GUI when the GUI is first displayed, or the dynamic interaction manager may wait until a data management component is needed before instantiating it, etc. The dynamic interaction manager may traverse the document object at any of various times, as appropriate to a specific embodiment.

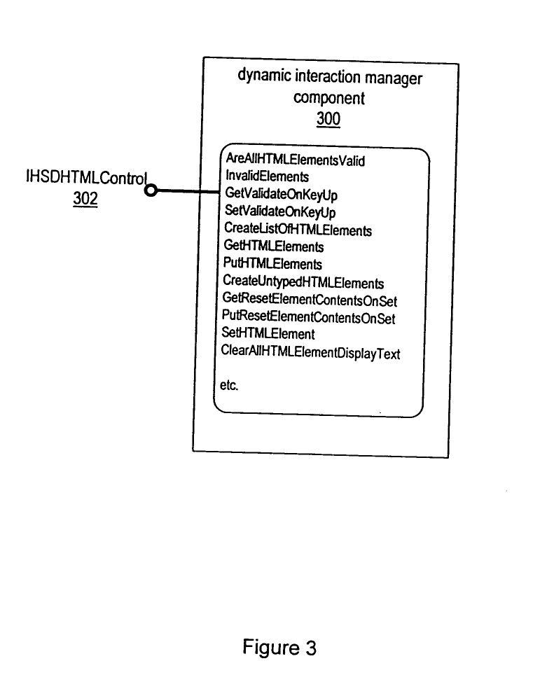

FIG. 3—Dynamic Interaction Manager Interface

The dynamic interaction manager may be implemented in various ways, including as a software component implemented using any of various component software specifications, e.g., as COM components, CORBA components, JavaBeans components, etc. In one embodiment, the Component Object Model (COM) is used for implementing the dynamic interaction manager.

In addition to automatically performing the types of data binding and data management operations discussed above, the dynamic interaction manager may provide methods that clients, e.g., application components, can call to perform various aspects of data management. FIG. 3 illustrates one embodiment of a dynamic interaction manager for use in conjunction with a GUI created from an HTML description.

FIG. 3 illustrates a dynamic interaction manager component 300, which exposes an IHSDHTMLControl interface 302. Appendix A provides an exemplary interface definition language (IDL) file for a COM implementation of the dynamic interaction manager component shown in FIG. 3.

As shown in FIG. 3, the IHSDHTMLControl interface includes various methods enabling clients to programmatically perform data management operations on GUI element data. For example, FIG. 3 shows an AreAllHTMLElementsValid( ) method. Clients may call this method as an alternative to, or in addition to, performing dynamic validation operations such as described above. For example, before storing GUI element data back in a data source, clients may call this method to request the dynamic interaction manager to use the data management information in the GUI element HTML descriptions to automatically perform validation operations, similarly as described above.

FIG. 3 also illustrates methods provided by the dynamic interaction manager for programmatically setting the default validation policy of the dynamic interaction manager, dynamically resetting GUI element values, etc.

In one embodiment, GUI element data is managed via the use of recordsets, such as ActiveX Data Objects (ADO) recordsets. For more information on recordsets, please refer to the above-incorporated references. Various of the methods illustrated in FIG. 3 may receive or return recordset parameters. For example, the GetHTMLElements( ) may dynamically retrieve the current HTML element values and create a recordset with these values. Clients may then access the data via the recordset.

Each GUI element markup language description may comprise data type information regarding the GUI element. For example, the HTML input form field description, discussed above with reference to FIG. 2 has an HSTYPE=“string” attribute. As another example, an HTML table cell description may appear as:

<TD

COLSPAN=3
ID==“htmlLOS”
HSDATASRC=#hsDHTMLRDS
HSDATAFLD=“length of stay”
HSTYPE=integer>

</TD>

where the HSTYPE=“integer” attribute specifies that table cell data is to be treated as an integer data type. In such a case, the dynamic interaction manager may automatically perform data conversion. For example, when the GetHTMLElements( ) method discussed above is called, the dynamic interaction manager may create a recordset comprising an integer field, where the integer value(s) of the recordset are set based on the current values of their associated GUI elements.

Note that the data type information may be used in combination with data management operations, such as the validation/formatting operations described above. For example, for an integer-typed GUI element; the dynamic interaction manager may be configured to automatically invalidate GUI elements with values comprising non-numeric data, without requiring the markup language author to specify validation/formatting information. Support for various other data types, including Boolean types, floating point types, etc., may be provided.

The dynamic interaction manager may also provide a means for grouping GUI elements in various ways. For example, the above HTML table cell description includes an HSDATASRC=#hsDHTMLRDS attribute. A different GUI element may instead have an HSDATASRC=#hsDHTMLRDS2 attribute, to designate that the element is associated with a different data source. As shown in the Appendix A IDL file, the dynamic interaction manager methods shown in FIG. 3 may take a data source parameter, to identify which group of GUI elements to get/set data for.

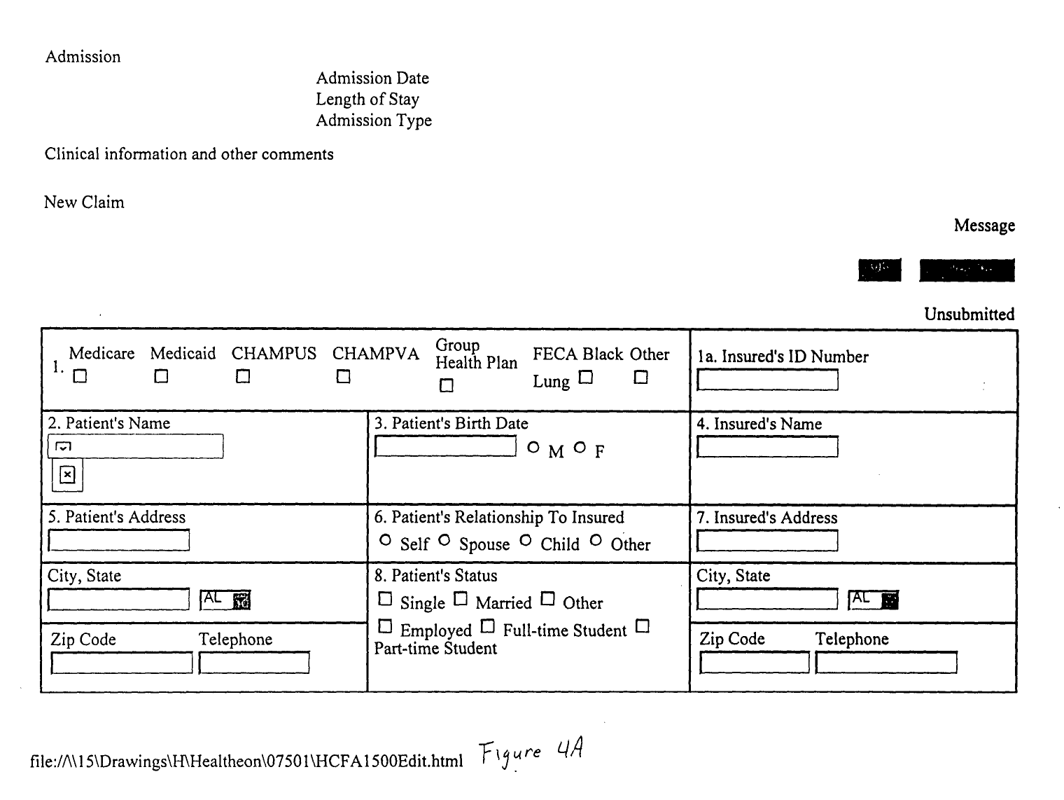

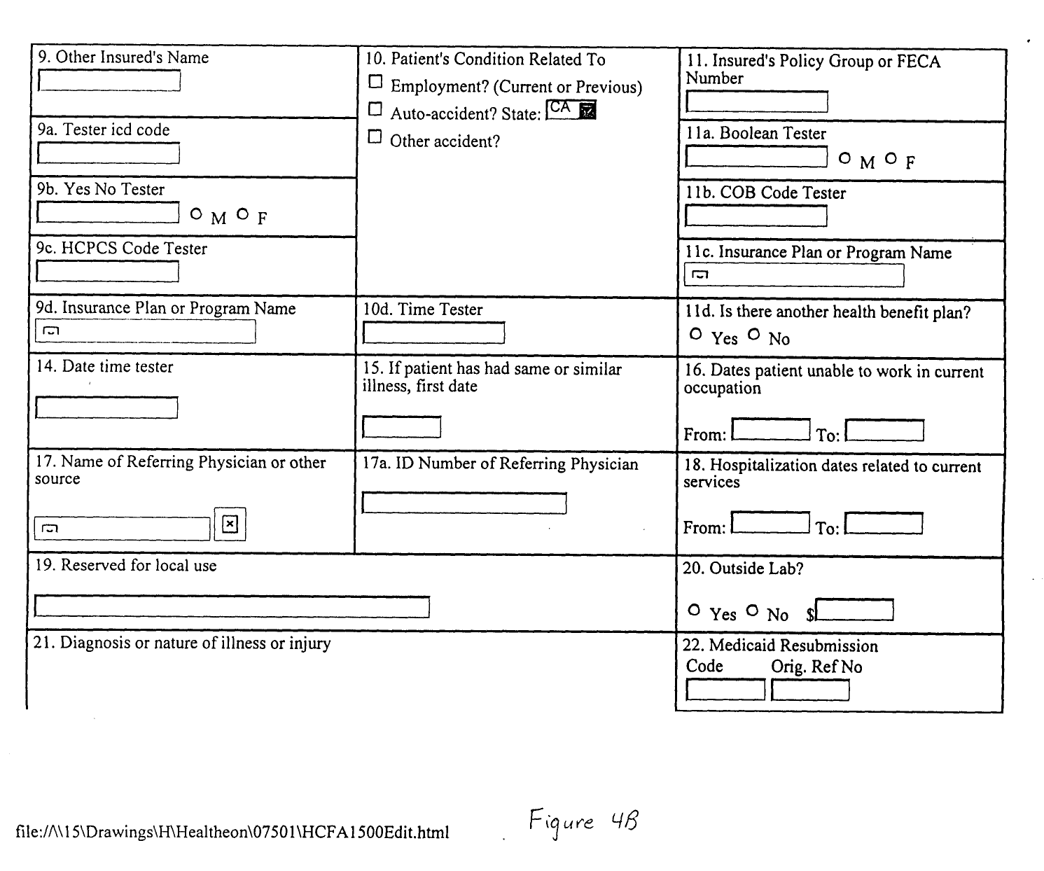

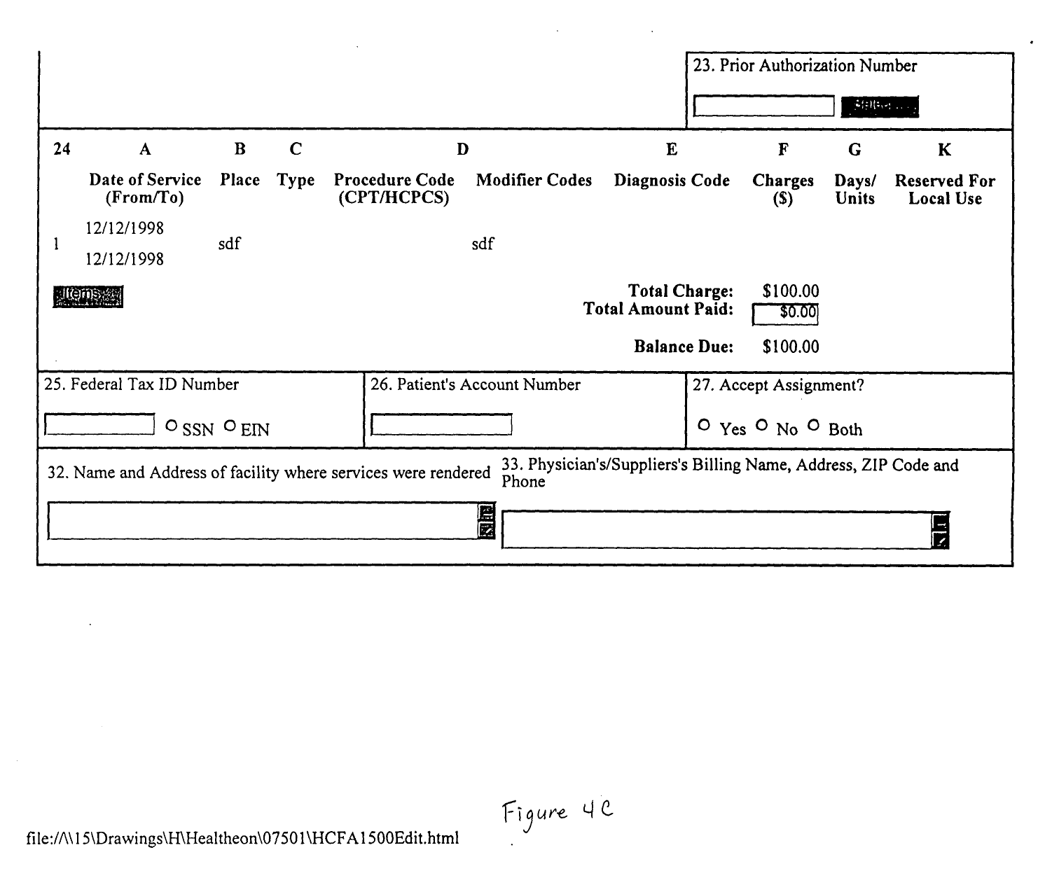

FIG. 4—HTML Example

As described above, the system and method described herein may be applied to application programs that process various types of markup language files. FIGS. 4A-4C illustrate an example of a GUI created from an HTML description, where the HTML description comprises information usable by a dynamic interaction manager for performing data binding and data management operations, such as described above. Appendix B illustrates the HTML file used to produce the FIG. 4 GUI.

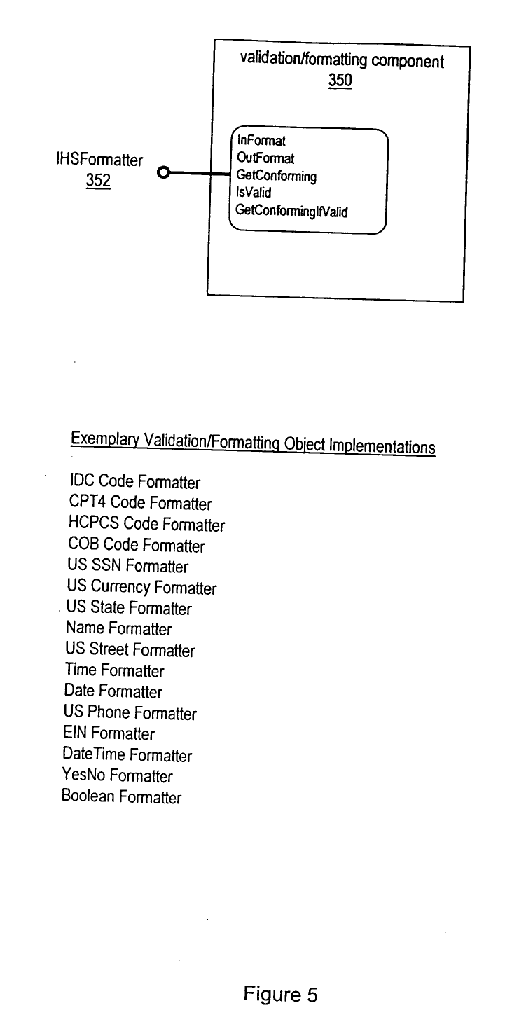

FIG. 5—Exemplary Embodiment of Validation/Formatting Interface

As discussed above, data management components may provide methods according to standard interfaces so that the dynamic interaction manager may call each data management component independently of the particular data management information associated with the component. For example, all data management components associated with performing validation/formatting operations may provide methods according to a standard validation/formatting interface. FIG. 5 illustrates one embodiment of such a validation/formatting interface.

In the FIG. 5 example, each validation/formatting component 350 supports an “IHSFormatter” interface 352, where this interface includes various methods related to performing validation/formatting operations. For example, the interface includes an IsValid( ) method that returns a boolean result indicating whether or not the string passed as an input parameter is a valid string according to the pattern or code associated with the validation/formatting component. The interface also includes a GetConforming( ) method that parses an input string according to the pattern or code and returns a formatted string.

The FIG. 5 interface also illustrates inFormat( ) and OutFormat( ) methods. The InFormat( ) method accepts a format code as a parameter, to inform other component methods, such as the IsValid( ) method, of which formatting pattern or code to use in parsing strings that are passed as input parameters. The OutFormat method accepts a format code as a parameter, to inform other component methods, such as the GetConfonning method, of which formatting pattern or code to use in formatting output strings. Thus, for compatible patterns/codes, text may be converted from one pattern/code to another.

It is noted that, although each pattern or code may have a unique associated validation/formatter component implementation, component implementations may also provide support for more than one pattern or code. For example, a particular validation/formatter component implementation may support both U.S. and European telephone codes. The component need only keep state information enabling it to determine which pattern or code to use at a particular time or for a particular client.

Also, although validation/formatting components are discussed in terms of a single component implementing both validation and formatting methods, the validation and formatting functionality may, of course, be separated into separate components.

FIG. 5 illustrates several exemplary patterns or codes. Each particular validation/formatting component implementation may implement the methods of the validation/formatting interface as appropriate for one or more of these patterns or codes, or other patterns or codes not shown in FIG. 5. In one embodiment, the Component Object Model (COM) is used for implementing validation/formatting components. Appendix A is a COM DL file including an exemplary definition for a validation/formatting interface, such as shown in FIG. 5.

In one embodiment, support may be provided for validating/formatting text according to the following codes, which include healthcare-specific codes:

International Classification of Diseases (ICD) code

Current Procedural Terminology (CPT) code

Coordination of Benefits (COB) code

HCFA Common Procedure Coding System (HCPCS) code

U.S. Employer Information Number (EIN)

U.S. Social Security Number

U.S. Currency

U.S. states and territories

U.S. telephone number system

U.S. zipcode system

human names

street names

time of day

date

date and time

yes/no

boolean value

The Appendix A IDL documents the corresponding pattern for each code. The listed codes are of course exemplary, and various other embodiments may support other types of codes.

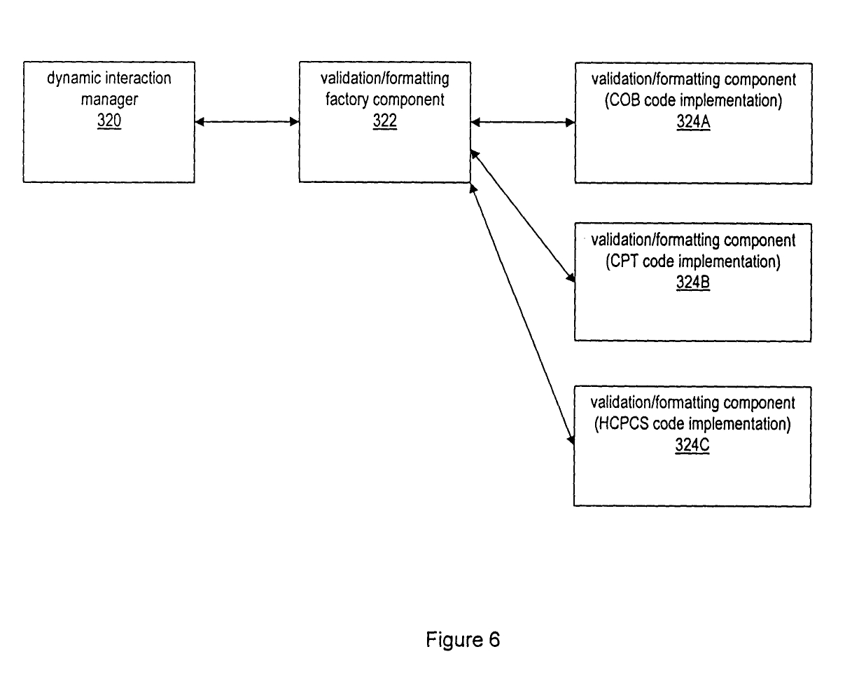

FIG. 6—Factory Component

As described above, the dynamic interaction manager may obtain a reference to a particular data management component via an intermediate factory component. FIG. 6 illustrates an embodiment employing a factory component.

The dynamic interaction manager may pass the factory component the value of an attribute in the markup language file as an argument in order to identify the appropriate data management component. For example, for a GUI element description comprising a HSFORMAT=“COBcode” attribute, the manager component may obtain this attribute information from the document object and pass the value “HSFORMATCOBcode” as an argument to the factory component, e.g. calling a “Get( )” method provided by the factory component, where this method returns a reference to an appropriate data management component, which may be a validation/formatting component associated with validating/formatting text according to the COB code in this case.

Healthcare Applications

The problem of performing validation/formatting operations for user interface text fields is a general problem that may apply to many types of applications. In particular, text validation/formatting is a common problem encountered by developers of healthcare applications. Various types of text patterns and codes are widely used in healthcare industry information systems. For example, illnesses and diseases are often represented by a particular code, such as an International Classification of Diseases code. Other types of codes commonly used in health insurance applications and other types of healthcare applications include Coordination of Benefits (COB) codes, Current Procedural Terminology (CPT) codes, HCFA Common Procedure Coding System (HCPCS) codes, etc.

Many healthcare workers, such as health insurance claim administrators, physician office receptionists, etc., continually work with applications requiring these codes as input or displaying these codes as output. Providing automatic text formatting capabilities in these applications may enable these healthcare workers to work with healthcare codes and other types of codes without being overly concerned with pattern demarcations, etc., which may greatly enhance the user-friendliness of the applications the workers interact with and may also increase the efficiency of the workers. Providing automatic text validating capabilities for text input may greatly increase healthcare information integrity by informing application users of erroneous input at the point of error. Providing these types of formatting/validating capabilities may be particularly important for applications which are intended to be part of a healthcare information network, in which information is shared across many applications, and where applications may expect information to be encoded or demarcated in particular ways.

Although the embodiments above have been described in considerable detail, numerous variations and modifications will become apparent to those skilled in the art once the above disclosure is filly appreciated. It is intended that the following claims be interpreted to embrace all such variations and modifications.

We claim:

1. A method for automatically managing data associated with a graphical user interface (GUI) element, the method comprising:
an application processing a markup language file, wherein the markup language file comprises a description of a graphical user interface (GUI), wherein the markup language file comprises a markup language tag for instantiating a dynamic interaction manager, wherein the description of the GUT comprises a description of a GUI element;
the application instantiating the dynamic interaction manager in response to said processing the markup language file;
the application displaying the GUI on a display screen of a computer system in response to said processing the markup language file;
a user interacting with the GUI element, wherein said interacting causes the application to send a programmatic event to the dynamic interaction manager;
the dynamic interaction manager performing an operation to manage data associated with the GUI element in response to receiving the programmatic event.

2. The method of claim 1,
wherein the GUI element is operable to receive text data;
wherein said user interacting with the GUI element comprises the user providing text data to the GUI element;
wherein said performing an operation to manage data associated with the GUI element comprises performing a validation operation on the text data.

3. The method of claim 2,
wherein said performing a validation operation on the text data comprises indicating that the text input provided to the GUI element is invalid if the dynamic interaction manager determines that the text input is not valid.

4. The method of claim 1,
wherein the GUI element is operable to receive text data;
wherein said user interacting with the GUI element comprises the user providing text data to the GUI element;
wherein said performing an operation to manage data associated with the GUI element comprises performing a formatting operation on the text data.

5. The method of claim 4,
wherein said performing a formatting operation on the text data comprises changing the appearance of text data displayed in the GUI element.

6. The method of claim 1,
wherein the markup language file description of the GUI element includes one or more data management attributes usable by the dynamic interaction manager in said performing the operation to manage data associated with the GUI element.

7. The method of claim 1, further comprising:
the dynamic interaction manager determining a data management component associated with the GUI element;
wherein said performing the operation to manage data associated with the GUI element comprises the dynamic interaction manager requesting the data management component to perform a data management operation on data associated with the GUI element.

8. The method of claim 7,
wherein the markup language file description of the GUI element includes one or more data management attributes;
wherein the dynamic interaction manager is operable to determine the data management component associated with the GUI element based on the one or more data management attributes.

9. The method of claim 1,
wherein the dynamic interaction manager is a COM object.

10. The method of claim 1,
wherein the markup language is HTML.

11. A memory medium for managing data associated with a graphical user interface (GUI) element, the memory medium comprising program instructions executable to:
process a markup language file, wherein the markup language file includes a description of a graphical user interface (GUI), wherein the description of the GUI comprises a description of a GUI element;
display the GUI on a display screen of a computer system in response to said processing the markup language file;
instantiate an executable dynamic interaction manager stored on the memory medium in response to processing a markup language tag referencing the dynamic interaction manager in the markup language file;
wherein the instantiated dynamic interaction manager is operable to perform an operation to manage data associated with the GUI element in response to user interaction with the GUI element.
